(19) United States
(12) Patent Application Publication
(10) Pub. No.: US 2022/0127958 A1
(43) Pub. Date: Apr. 28, 2022

(54) Filer Communicatively Coupling an Operator Device

(71) Applicant: Gibson Reports, LLC, Wimberley, TX (US)

(72) Inventors: David Gibson, Wimberley, TX (US); Daniel Gibson, San Antonio, TX (US)

(73) Assignee: Gibson Reports, LLC, Wimberley, TX (US)

(21) Appl. No.: 17/081,091

(22) Filed: Oct. 27, 2020

(51) Int. Cl. E21B 49/00; G06Q 50/02; G01V 1/30; G06F 16/29

(52) U.S. Cl. CPC E21B 49/003; G06F 16/29; G01V 1/306; G06Q 50/02

(57) ABSTRACT

The present disclosure relates to a method of implementing a filer configured to interface between an operator device and a website operated by a regulatory body. The method includes the filer: providing a web form to the operator device; receiving an indicator associated with a location; retrieving filer data from a database communicatively coupled to the filer, where the filer data is associated with the indicator. The method also includes transmitting confirmation data associated with the filer data to the operator device; receiving verification that the confirmation data is associated with the locations; prompting the operator device for additional information associated with work at the location; and formatting the additional information to create submission data, where a format of the submission data is defined by the website operated by the regulatory body.

### BACKGROUND

Various entities collect a large amount of data as part of their jobs. For example, an operator in an oil field, may gather large amounts of data related to drilling, surveying, extracting, and plugging operations. A regulatory body may be tasked with ensuring the various entities comply with rules, regulations, and best known practices. A regulatory body may be tasked with gathering data from the various entities and verifying the entities comply with the rules, regulations, and best known practices. As part of the endeavor to collect the most up-to-date and accurate information, a regulatory body may provide a website through which the various entities submit data.

### SUMMARY

A method is disclosed of implementing a filer that interfaces between an operator device and a website operated by a regulatory body. In one embodiment, the method includes providing a web form to an operator device; receiving an indicator associated with a location; retrieving filer data from a database communicatively coupled to the filer, where the filer data is associated with the indicator. The method further includes transmitting confirmation data associated with the filer data to the operator device; receiving verification that the confirmation data is associated with the location; prompting the operator device for additional information associated with work at the location, where the additional information includes field data; and formatting the additional information to create submission data, where a format of the submission data is defined by the website operated by the entity

In one disclosed embodiment, a system is configured to implement a filer that interfaces with a website operated by an entity. The system includes a processor; a memory coupled to the processor, where the memory stores a program implementing the filer. The filer provides a web form to an operator device and receives new well data associated with the new well. In one embodiment, the new well data includes at least one selected from the group consisting of: a rig name, a drill floor elevation, a north reference, an elevation, a northing, an easting, a target bearing, a target formation, a latitude, a longitude, a geo system, and map zone. The filer prompts the operator device for additional information associated with work at the new well, where the additional includes field data; and formats the additional information to create submission data, where a format of the submission data is defined by the website operated by the entity.

In one disclosed embodiment, one or more non-transitory computer-readable storage media store instructions that implement a filer. The filer provides a web form to an operator device; receives an indicator associated with a location; and retrieves filer data from a database communicatively coupled to the filer. The filer data is associated with the indicator. The filer transmits confirmation data to the operator device, where the confirmation data is associated with the filer data; receives verification that the confirmation data is associated with the location. The filer prompts the operator device for additional information associated with work at the location and formats the additional information to create submission data. In one embodiment, the additional information includes field data. In one embodiment, a format of the submission data is defined by the website operated by the entity.

### BRIEF DESCRIPTION OF THE DRAWINGS

For a detailed description of various embodiments, reference will now be made to the accompanying drawings in which:

FIG. 1 shows, in block diagram form, an example system architecture, in accordance with some embodiments.

FIG. 2 shows a sequence diagram illustrating a method of using the filer, in accordance with some embodiments.

FIG. 3a shows an example screen on an operator device, in accordance with some embodiments.

FIG. 3b shows an example screen on an operator device, in accordance with some embodiments.

FIG. 3c shows an example screen on an operator device, in accordance with some embodiments.

FIG. 4 shows an example screen on an operator device, in accordance with some embodiments.

FIG. 5a shows an example screen on an operator device, in accordance with some embodiments.

FIG. 5b shows an example screen on an operator device, in accordance with some embodiments.

FIG. 6 shows an example screen on an operator device, in accordance with some embodiments.

FIG. 7 shows an example screen on an operator device, in accordance with some embodiments.

FIG. 8a shows an example screen on an operator device, in accordance with some embodiments.

FIG. 8b shows an example screen on an operator device, in accordance with some embodiments.

FIG. 9 shows an example screen on an operator device, in accordance with some embodiments.

FIG. 10a shows an example screen on an office device, in accordance with some embodiments.

FIG. 10b shows an example screen on an office device, in accordance with some embodiments.

FIG. 10b shows an example screen on an office device, in accordance with some embodiments.

FIG. 10c shows an example screen on an office device, in accordance with some embodiments.

FIG. 10d shows an example screen on an office device, in accordance with some embodiments.

FIG. 11 shows a method, in accordance with some embodiments.

FIG. 12 shows a method, in accordance with some embodiments.

FIG. 13 shows a method, in accordance with some embodiments.

FIG. 14 shows a detailed view of a computing device that can represent the computing devices described herein, used to implement various methods and system architectures described herein, in accordance with some embodiments.

It should be noted that the structures and timing diagrams depicted in the various figures are not necessarily drawn to scale, but rather are drawn in a manner to more clearly illustrate the teachings depicted therein.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Various terms are used to refer to particular system components. Different companies may refer to a component by different names—this document does not intend to distinguish between components that differ in name but not function. In the following discussion and in the claims, the terms “including” and “comprising” are used in an open-ended fashion, and thus should be interpreted to mean “including, but not limited to . . . ”. Also, the term “couple” or “couples is intended to mean either an indirect or direct connection. Thus, if a first device couples to a second device, that connection may be through a direct connection or through an indirect connection via other devices and connections.

At least some of the example embodiments are directed to a filer configured to interface between an operator device and a website operated by a regulatory of government body. A regulatory body, tasked with ensuring the various entities comply with rule, regulations, and best known practices, may gather data from various entities for jobs that fall within the jurisdiction of the regulatory body. For example, a regulatory body tasked with regulating the oil and gas industry, may collect data from entities conducting business in the oil and gas sector. As part of the endeavor to collect the data, the regulatory body may provide a website, where an entity may submit collected data. The means to collect data through a website is used for illustrative purposes only, and not meant to be a limiting example. Any means may be used by the regulatory body to collect data. For example, a regulatory body may collect data through email, an internet of things (IoT) infrastructure, a shared drive, a cloud storage service, physical mail, etc.

Any improvements to increase the speed and accuracy of data collection efforts on the part of the regulatory body as well as the regulated entities is beneficial. That is, any improvements that help improve the accuracy of, and streamline the process of conveying the data from the regulated entities to the regulatory body is beneficial to the oil and gas sector as a whole. Such applications, as described herein, are not limited to the oil and gas sector, and would be applicable to sectors where a regulatory body and regulated entity exchange data.

One example of a regulatory body in the state of Texas is the Railroad Commission of Texas (RRC). The RRC is a state agency that regulates the oil and gas industry, gas utilities, pipeline safety, safety in the liquified petroleum gas industry, and surface coal and uranium miming. In one non-limiting example, entities operating in the oil and gas industry in Texas may collect data related to drilling wells. As the RRC is the governing body for the oil and gas industry in the state of Texas, the RRC also serves as a repository for the various data reported by the respective entities.

In this example, as part of its regulatory duties, the RRC collects data from the various regulated entities through a website. Often the RRC may accept data submitted electronically through a website operated on behalf of the RRC. The website may introduce additional formatting requirements defined based on the architecture of the website and database within which the RRC stores data. For example, the website might expect a particular file format (e.g., WORD, Portable Document Format (PDF), EXCEL, etc.). Additionally, the website may identify the type of data submitted based on an HTML tag attached to the submitted document and request a statement from the regulated entity certifying the information in the reports are true and accurate.

In various embodiments, a filer is described that interfaces with both the operating entity or regulated entity and the regulatory or government body. In one embodiment, the filer collects data from a field operator (e.g., employed by the regulated entity), and reports the data to the regulatory or government body on behalf of the regulated entity. The filer helps reduce the time spent by the regulated entity in reporting the data to the regulatory body. This in turn, increases the turnaround time period, defined as the time at which the data is collected to the time at which the data is reported to the regulatory body. A faster turnaround time helps reduce current backlogs regarding data that needs to be reported to the regulatory body. A reduced turnaround time, in turn, enables the regulatory body to receive more up to date data related to operations and jobs being performed by the regulated entities. Furthermore, as will become apparent to one of ordinary skill in the art, the filer increases the accuracy of reported data. Additionally, the ability to reduce the time and resources an entity spends on reporting data in accordance with expectations of the regulatory or government body is beneficial, as it reduces overhead costs associated with work performed in an oil field.

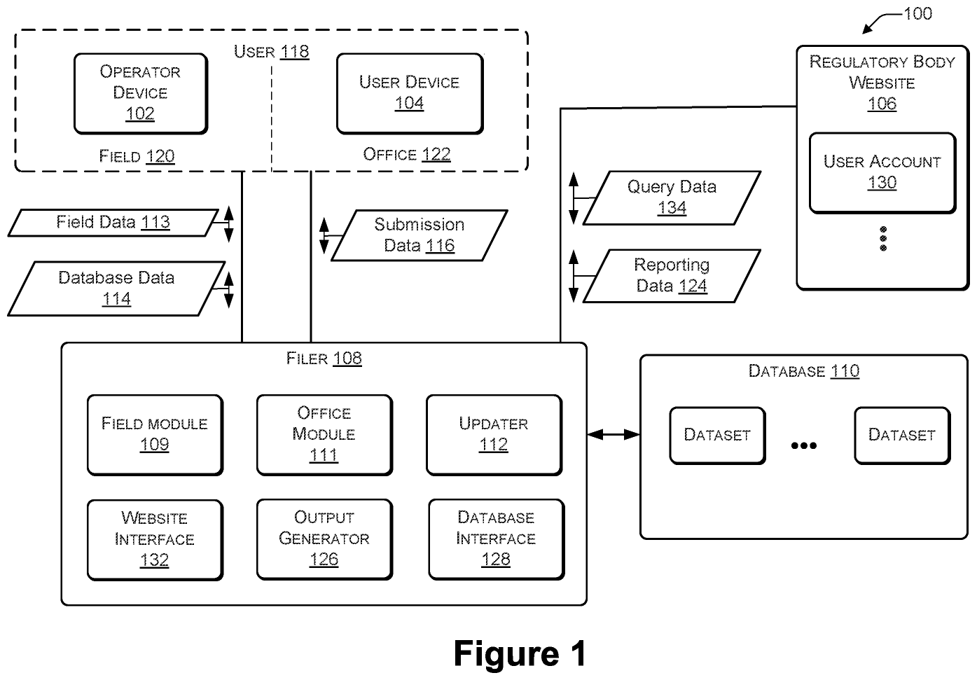

The applications of the filer described herein are not limited to the example discussed above with regards to an entity operating in an oil field. As would be apparent to a person having ordinary skill in the art, the applications of the described filer extend beyond the oil and gas industry. For example, the filer may be used in any environment in which data is collected by an entity, and the entity has a duty to report the collected data to a regulatory or government entity. In another example, the filer may be configured to interface with objects in an internet of things (IOT) environment; where respective objects provide data that is collected, formatted, and reported by the filer. Turning to FIG. 1, an embodiment of the filer is described.

FIG. 1 illustrates an example system architecture 100 in block diagram form, in which a filer interfaces between a regulatory body website and a user. The filer may collect field data from the user and report the data to a regulatory or government body on behalf of the user. The example system architecture 100 includes an operator device 102, a user device 104, a regulatory body website 106, a filer 108, and a database 110 communicatively coupled to the filer 108. The example architecture 100 is not meant to be limiting and other system architectures can be used to collect field data without departing from the scope of this disclosure.

The filer 108 may represent one or more computing devices, e.g., a personal computing device, desktop computing device, a rack-mounted computing device, a server device etc., where each computing device, respectively, includes at least one processor, at least one memory, and at least one storage (e.g., a hard drive, a solid-state storage device, a mass storage device, and a remote storage device). In one embodiment, the filer 108 is implemented on a distributed computing system. The foregoing example computing devices and systems are not meant to be limiting. Individual computing devices implemented as part of the filer 108 can be any form of computing device or part of any type of computing system without departing from the scope of this disclosure.

In one embodiment, the filer 108 is maintained by an entity (e.g., filer entity) that provides the filer to various regulated entities who in turn, have reporting obligations to a regulatory or government body. As described herein, the filer 108 interfaces between the regulatory body website 106 and devices operated by the user 118 to improve a data collection process between the user 118 and the regulatory body. Accordingly, in FIG. 1, the filer 108 is communicatively coupled to the operator device 102 and the user device 104. The filer 108 is also communicatively coupled to a regulatory body website 106 by any known methods of coupling computing devices.

The filer 108 may be communicatively coupled to the operator device 102, the user 104, or the entity website 106 through any means of communicative coupling known in the art. For example, the various devices may be coupled by way of wired technologies (e.g., ETHERNET) and wireless technologies (e.g., WiFi®, code division multiple access (CDMA), global system for mobile (GSM), universal mobile telephone services (UM TS), Bluetooth®, ZigBee®, etc.). In one example, the operator device 102 may use a wireless technology (e.g., WiFi®, CDMA, GSM, etc.) to connect to the filer 108, while the filer 108 may use a wired connection to connect to the regulatory body website 106.

Additionally, the filer 108 is communicatively coupled to a database 110. The database 110 may be located on the same computing device within which the filer 108 is executed, or the database 108 may be partially or entirely located on a computing device separate from the computing device within which the filer 108 is executed. The database 108 defines an organized collection of data. The database 110 may include both the organized collection of data as well as a database management system accessible by the filer 108. In other embodiments, the database management system is executed within the filer 108 (e.g., within the database interface module 116). Any known combination of database and database management systems is contemplated by this disclosure and the architecture 100 illustrated in FIG. 1.

In one embodiment, the filer 108, is configured to collect data (e.g. field data 113) from an operator device 102, generate submission data 116 based, in part, on the field data 113, and generate reporting data 124 based on the submission data 116. The filer 108 is further configured to transmit the reporting data 124 to the regulatory body website 106, based on a directive provided by the user device 104. Accordingly, the filer 108 is also configured to interface with a website (e.g., regulatory body website 106) owned by the regulatory or government body.

In FIG. 1, example modules illustrated in the filer 108 including a field module 109, an office module 111, an updater 112, a website interface 132, an output generator 126, and a database interface 128. Each module and respective functions will be described in turn in more detail below. Additionally, the example modules executing within the filer 108 are not meant to be limiting and simply illustrate one example architecture that implements the features, techniques, and configurations of the filer 108 as described herein. As will be recognized by a person of ordinary skill in the art, the features and techniques executed by the filer 108 may be implemented using the same, or different combination of modules.

For purposes of the discussion of FIG. 1, the user 118 is a regulated entity that operates within the oil and gas industry. In one example, the filer 108 enables the user 118 to collect data associated with various oil rigs, machinery, and equipment. The filer 108 additionally reports the collected data on behalf of the user 118 to the regulatory body website 106. Various reports may be associated with work done on oil rigs, machinery, and equipment, or work done in an oil field (e.g., drilling, decommissioning a well, recommissioning a well). Alternatively, a regulatory or government body receive the data from work done by the user 118 by way of the filer 108. In yet another example, the operator device 102 may represent one or more sensors configured to collect data associated with various machines operating in the oil field. That is, the operator device 102 is not limited to being a single device operated by one person. Overall, the operator device 102 represents the means through which the filer 108 collects various data.

In FIG. 1, the user 118 may be conceptually separated into two areas. The first area is the field 120, and the second area is the office 122. The field 120 represents locations in an oil field where machinery is operated in relation to a job within the oil and gas industry. In one example, operators may perform various tasks including drilling wells in a field 120. A respective operator may use an operator device 102 to record data as a well is drilled. In other examples, the operator device may include individual sensors of respective equipment operating in the field 120, where the equipment may be operated remotely, in-person, automatically, and manually, etc. The data may relate to characteristics of the well, characteristics of the tool used to drill, and other characteristics related to the job of drilling a well.

The office 122 represents locations that may be in an oil field or may be elsewhere (e.g., offsite). The office 122 represents a location where tasks are performed that do not necessarily have to be performed at a respective oil field. In various embodiments, office personnel at the office 122 may use a user device 104 to review data collected by an operator device 102 and transmit a report indicator to the filer 108 for respective data. In one example, the operator device 102 represents a sensor coupled to equipment, and the user device 104 may pull the data from the sensor. In another example, the filer 108 is set up to automatically pull the data from the operator device 102 and/or user 118.

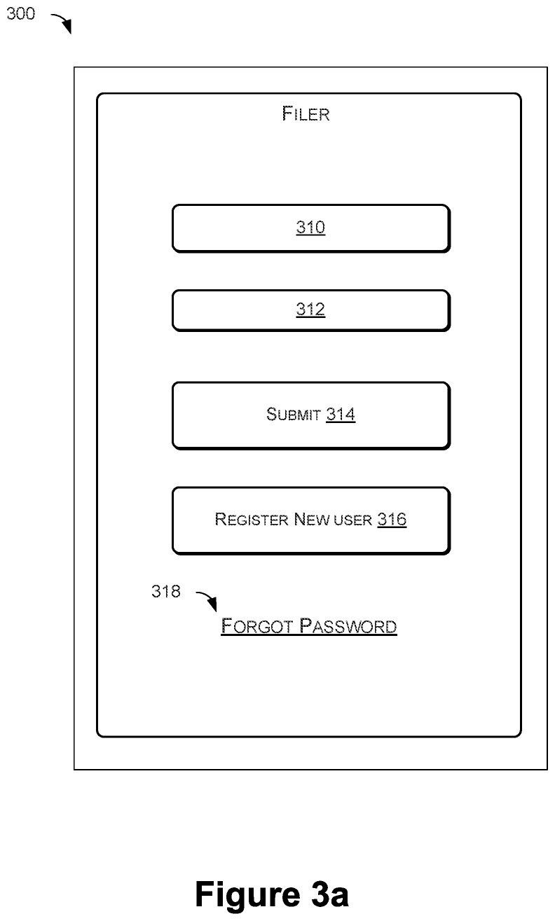

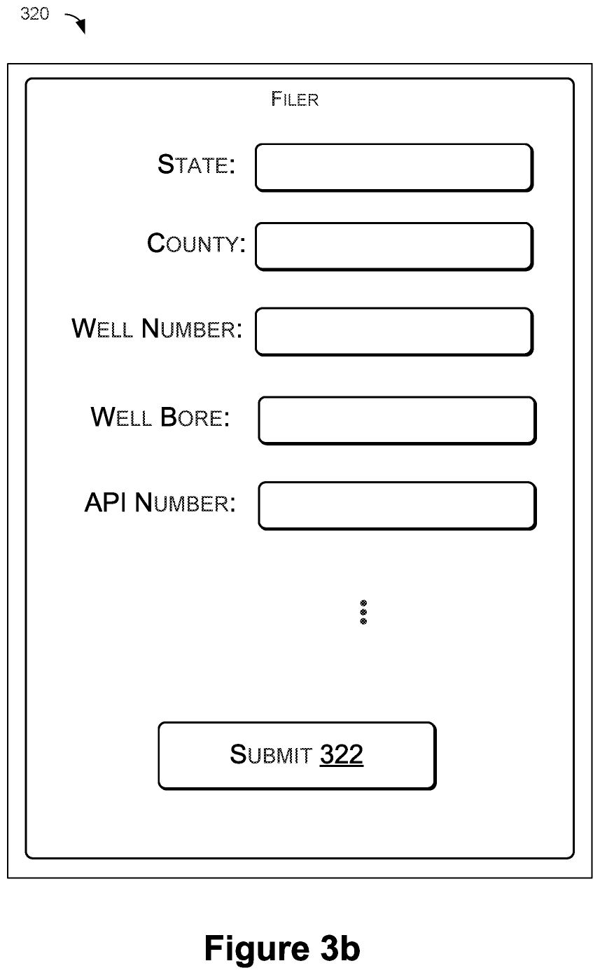

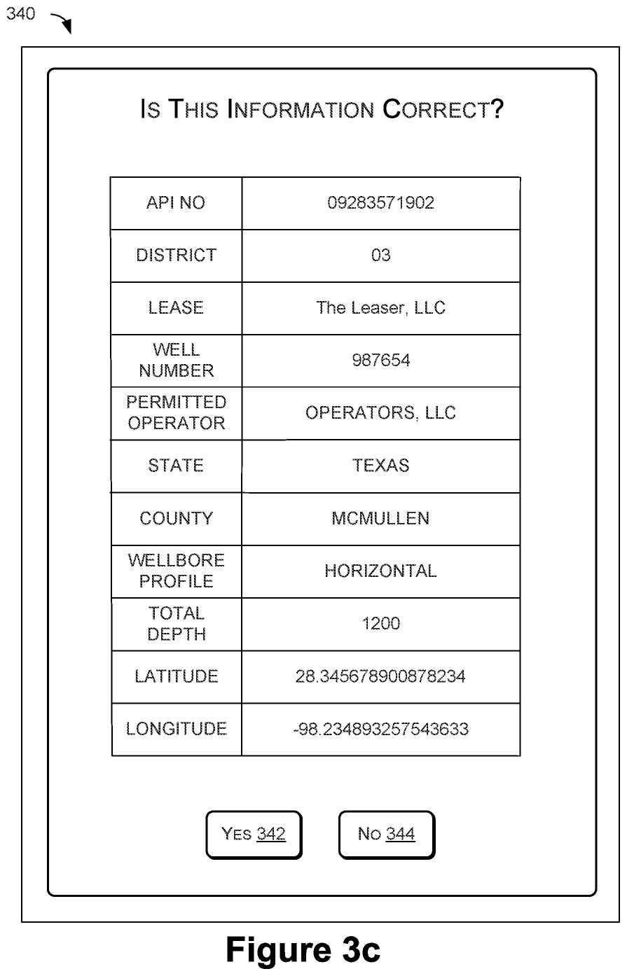

With regards to the interfaces between the filer 108 and the user 118, the filer module 109 is configured to interface with the operator device 102 (e.g., in the field 120), while the office module 111 is configured to interface with the user device 104 (e.g., in the office 122). The field module 109 is configured to exchange data such as database data 114 and obtain data related to a particular job (e.g., field data 113). In accordance with some embodiments, an operator in the field 120 may initially use the operator device 102 to log in to an application or webpage to access the filer 108. Various aspects of an example web form are discussed in FIGS. 3-9.

In response to receiving log in information from the operator device 102, the field module 109 may generate and transmit a web form, which the operator device 102 renders for display on the operator device. The field module 109, by way of the web form, requests data from the operator device 102 related to a job performed in the field. For example, the field module 109 may request data about whether the job includes drilling a new well or an existing well.

In the event the job includes drilling a new well, the operator device 102 transmits a response (e.g., field data 113) indicating a new well. In response, the field module 109 requests additional information about the new well, including: a name of the rig, drill floor elevation, north reference, elevations, northing, easting, target bearing, target formation, latitude, longitude, geo system, and map zone. The operator device may register a new well by responding to the additional information request, which is transmitted to the filer 108 (e.g., field data 113). Upon receiving the additional information, the field module 109 may store the additional information associated with the new well in the database 110 (e.g., by way of the database interface 128). Accordingly, the database 110 is structured to store information related to drilling respective wells (new or existing).

In the event the job includes drilling an existing well, the operator device 102 transmits a response (e.g., field data 113) indicating an existing well and an associated identifier of the existing well. In response, the field module 109 requests information associated with the existing well from the database 110. For example, the field module 109 may transmit the identifier of the existing well, and query the database 110 for additional data (e.g., query data 134).

In FIG. 1, when the filer 108 accesses the database 110, the filer 108 may utilize the database interface 128. An access to the database 110 includes both retrieving and storing data within the database 110. Accordingly, the database interface 128 may enable the filer 108 to input queries to the database 110. The database interface 128 may include a web client, a local client running on the computing device executing the filer 108, a mobile application, etc.

In the example where the job includes drilling an existing well, the operator device 102 may transmit associated identifiers of the existing well including, but not limited to: a state, a county, a well number, a well bore, and an American Petroleum Institute (API) number. The API number, in this example is a unique, permanent, numeric or alphanumeric identifier assigned to a wellbore for purposes of identification. This example is not meant to be limiting and any type of identifiers may be transmitted to identify a respective well. For example, a unique well identifier (UWI) may be used.

Additional data associated with the existing well that may be transmitted from the database 110 and back to the filer 108 may include, but not limited to: a district identifier, an identifier of an entity who owns a lease (e.g., lease name), a well number, an identifier of a permitted operator (e.g., operator name), a wellbore profile, a total depth, and latitude, and a longitude. As is the case throughout this disclosure, this example is not meant to be limiting and any type of additional data associated with the existing well may be transmitted to the filer 108.

In various embodiments, the additional data associated with the existing well stored in the database 110 reflects information stored by the regulatory or government body that operates the regulatory body website 106. That is, the data in the database 110 is synchronized or partially synchronized with a repository of the regulatory or government body.

In FIG. 1, the filer 108 synchronizes the database 110 with the repository of the regulatory or government body by way of the updater 112. In one example, updater 112, queries the regulatory body website 106 for data associated with various user accounts. The updater 112 queries the regulatory body website 106 periodically, or in response to an event. For example, the updater 112 may query the regulatory body website 106 daily, twice daily, weekly, monthly, bi-monthly, etc. Any pattern of frequency may be used by the updater 112. Alternatively, the updater 112 may query the regulatory body website 106 after transmitting reporting data 124 or in response to other events.

In one embodiment, the updater 112 includes capabilities to automate or mimic website actions such as clicks, entering a username and password, navigating to particular sections of the regulatory body website 106, and submitting queries based on a particular user account, location, type of well, date range, or various other factors. Additionally, updater 112 includes the capability of receiving data associated with a query response (e.g., query data 134) and storing the data in the database 110 (by way of the database interface 128). In one example, the updater 112 implements aspects of an application programming interface (API) and web scraper.

In various examples, the updater 112 is configured to submit a respective search query to the regulatory body website 106. The updater 112 receives a response from the regulatory body website 106, and parses out one or more portions of the response and stores information from the portions into the database 110. In one example, the filer 108, by way of the updater 112, submits a GET/POST request with one or more parameters to a uniform resource locator (URL) that the regulatory body website 106 listens on. Upon receiving the POST request, the regulatory body website 106 responds with a Hypertext Markup Language (HTML) response (HTML response) based on the parameters received from the filer 108. The regulatory body website 106 provides the HTML response to the filer 108. In turn, the filer 108 parses the HTML response and pulls out respective data elements that are, in turn, stored in the database 110. The filer 108 may request additional data through additional GET/POST requests as needed to one or more URLs hosted by the regulatory body website 106.

In addition to data received from the regulatory body website 106, the database 106 also includes data received from the user 118. After completing a job, the operator device 102 may transmit an indicator having a value of “done” or “complete” through the web form. In one example, a drilling operation may be conceptually divided into portions or runs. In this example, the operator may indicate he has completed a run. In response to receiving the indicator having the value of “done” or “complete”, the filer 108 next engages with a user device 104.

In FIG. 1, the filer 108 exchanges data associated with a job completed in the field 120 (e.g., submission data 116) with the user device (e.g., associated with the office 122) and generates reporting data 124 that is submitted to the regulatory body website 106. In one example, a user may use the user device 104 to log in to an application or webpage to access the filer 108. The filer 108 may interface with the user device 104 by way of the office module 111.

In response to the office module 111 receiving log in information and an indicator the user device 104 would like to access information associated with completed jobs, the user device 104 accesses submission data 116. In one example, after receiving field data 113, the office module 111 may direct the output generator 126 to generate submission data 116 based on the received field data 113.

In some examples, the output generator 126 may reference data format rules defined by the website interface 132 to determine a format of the submission data 116. In other examples, the rules for formatting the submission data 116 are defined within the output generator 126. In additional embodiments, the website interface 132 may determine the rules for formatting, based on information retrieved from the regulatory body website 106, and implement the rules within the output generator 126.

Still referring to FIG. 1, in various embodiments, formatting the submission data 116 also includes executing various conversions and calculations based on the received field data 113. For example, the field data 113 may represent a raw data set that is then interpreted to generate the submission data. In one embodiment, the output generator 126 may execute various conversions and calculations based on the received field data 113.

For example, the output generator 126 may calculate a true vertical depth, vertical section, north/south, east/west, or dogleg severity from the received field data 113. In one example, the output generator 126 calculates values for true vertical depth, vertical section, north/south, east/west or dogleg severity from parameters including a measured depth, inclination, azimuth, or target bearing. In one example, a target bearing may come from a well and may have the same value across all surveys. In another example, a dogleg value may be calculated by the output generator 126. The output generator 126 may further calculate a dogleg severity based on the calculated dogleg value.

Additionally, formatting the submission data 116 includes accessing additional data in the database 110 and generating documents needed to complete a submission with the regulatory body website 106. For example, the output generator 126 may generate a plat document associated with the well, and a certification statement.

Accordingly, the user device 104 may access the submission data 116, and an office personnel may review the data and verify accuracy. In one example, the office personnel may confirm the data is complete and represents work completed by the user 118 (e.g., by an operator in the field 120). In the event the office personnel concludes the submission data 116 is inaccurate (e.g., submission data 116 needs revision, or information is missing), the user device 104 may transmit a revise indicator to the filer 108 indicating as such. For example, the user device 104 may transmit a revise indicator having a value of “needs revision” or “send back to operator device”.

In one example, where the user device 104 indicates the submission data 116 associated with a particular job needs to be sent back to the field 120, in response, the filer 108 may mark the data associated with the job as incomplete. When an operator logs into the filer 108 using the operator device 102, the filer 108 may display the jobs marked as incomplete and enable an operator to submit revisions or additional data to complete the job.

Still referring to FIG. 1, and interactions between the user device 104 and the filer 108, in the event the office personnel concludes the submission data 116 is accurate and ready for submission, the user device 104 may transmit an indicator (e.g., report indicator) to the filer 108 (e.g., the office module 111) indicating as such. In several embodiments, the office personnel may choose to either submit the data with the regulatory body website 106 or save the data with the regulatory body website without submitting the data 106. In the event the data is saved without being submitted, the data may be stored or associated with the user account 130. At some point later, the user 118 may access the saved data and submit the data.

Accordingly, the user device 104 may respond to accessing the submission data 116 by specifying to the filer 108 whether to save the data or submit the data using a report indicator. Accordingly, in one example, the report indicator may be one of: a submit value or a save value.

In the example where the user device 104 transmits a report indicator having a value of submit, the filer 118 proceeds with generating reporting data 124 based on the submission data 116, and submits the reporting data 124 to the regulatory body website 106 on behalf of the user 118. In one embodiment, the filer 108 provides the regulatory body website 106 with respective tags and commands, that indicate to the regulatory body website 106 that reporting data 124 is being submitted on behalf of the user 118. That is, from the perspective of the regulatory body website 106, reporting data 124 is submitted on behalf of user 118, having user account 130.

In one example, the filer 108 uses the website interface 132 and output generator 126 to submit the reporting data 124 to the regulatory body website. For example, the output generator 126 may format the reporting data 124 according to the formatting rules defined within the filer 108 for submissions to the regulatory body website 106. In one example, the output generator 126 may generate files in a portable document format (pdf) containing the reporting data 124. Additionally, the output generator 126 may generate a certification statement that confirms the data submitted is accurate and being submitted by the user 118.

In some embodiments, a website interface 132 executing within the filer 108 is configured to determine an architecture of the website 106 and determine a format of the reporting data 124 that is compatible with the regulatory body website 106. In one example, the website interface 132 may help define the format the filer 108 uses when utilizing the output generator 126 to convert submission data 116 to reporting data 124.

The website interface 132 also implements the ability of the filer 108 to transmit the reporting data 124 to the regulatory body website 106 on behalf of the user 118. In one embodiment, the website interface 132 includes capabilities to automate or mimic website actions such as clicks, entering in a username and password, navigating to particular sections of the regulatory body website 106, and submitting or saving documents on behalf of the user 118.

In one example, the website interface 132 defines the kinds of calls or requests that are compatible with the website 108 and defines a data format of the reporting data 124. In additional embodiments, the website interface 132 implements aspects of an application programming interface (API) and web scraper. Thus, the website interface 132 may submit the reporting data 124 by automating or mimicking the website actions of logging in as the user 118, accessing the user account 130, navigating to a submit section of the regulatory body website 106, and submitting the reporting data 124 on behalf of the user 118. Accordingly, the filer 108 is configured to transmit the reporting data 124 on behalf of a respective regulated entity, such as user 118.

In other embodiments, the user device 104 may confirm that data ready to be submitted (e.g., submission data 116) is accurate, and the user device 104 may request the filer 108 save the submission data 116 at the regulatory body website 106, without submitting it. That is, the filer 108 may receive one of two report indicators from the user device 104: a submit value or a save value. Alternatively, the filer 108 may receive a revise indicator from the user device 104. The filer 108 responds accordingly.

In response to a save value, the filer 108 generates reporting data 124 based on the submission data 116. Similar to the steps for submitting the reporting data 124, the filer 108 may use the website interface 132 and output generator 126 to save the reporting data 124 to the regulatory body website. For example, the output generator 126 may format the reporting data 124 according to the formatting rules defined within the filer 108 for submissions to the regulatory body website 106. In one example, the output generator 126 generates reporting data 124, based on the submission data 116, in the pdf format.

Further, the filer 108 provides the reporting data 124 to the regulatory body website 106, along with respective commands, that indicate to the regulatory body website 106 that the reporting data 124 is to be saved within an account of the user 118 (e.g., user account 130). For example, the website interface 132 implements the ability of the filer 108 to transmit and save the reporting data 124 to the regulatory body website 106 on behalf of the user 118. The website interface 132 includes capabilities to automate or mimic website actions such as clicks, entering in a username and password, navigating to the user account 130 and saving the reporting data 124 under the user account 130. That is, from the perspective of the regulatory body website 106, reporting data 124 is saved without being submitted, to the user account 130.

In various embodiments, after reviewing the submission data 116, the user device 104 may also transmit a revise indicator. The office personnel may conclude the submission data includes inaccuracies and that an operator should revise submitted field data. In response to a revise indicator, the filer 108, by way of the field module 109, presents the previously submitted field data to the operator device 102 and prompts the operator to revise the previously submitted field data.

In FIG. 1, the user account 130 is an account within the regulatory body website 106 that is associated with the user 118. In some embodiments, after the reporting data 124 is saved under the user account 130, the user device 104 or the operator device 102 may log in to the regulatory body website 106, view saved reporting data 124, and subsequently submit the reporting data 124.

By utilizing the features of the filer 108 as described in FIG. 1, a regulatory body may receive information from a regulated entity more quickly and an accuracy of the data may be improved. For example, the filer 108 reduces the time that might be spent by office personnel to gather and review data collected in the field 120. As the filer 108 is configured to collect the field data, and format the field data into a submission data or reporting data, the office personnel can allocate time and resources to reviewing an accuracy of data that might otherwise be spent on formatting. The formatting task might also include converting units of data or additional calculations based on the field data.

As the filer 108 reduces the time that might be spent by the office personnel to format or generate reporting data, the backlog that might otherwise be present due to office bandwidth constraints, is also reduced. Example backlogs present in various industries may range from weeks to six months. In other examples, a backlog may be several years or in some examples, a regulated entity fails partially or entirely to report data to the regulatory body. As the filer 108 enables quicker turnaround times, the regulatory body receives the reporting data 124 faster and has more current information. As such, the filer 108 introduces efficiencies in data transfers and exchanges that may occur between regulated entities and the regulatory body. Accordingly, the methods and features of the filer 108 are beneficial to both regulated entities and a regulatory body collecting data from the regulated entity.

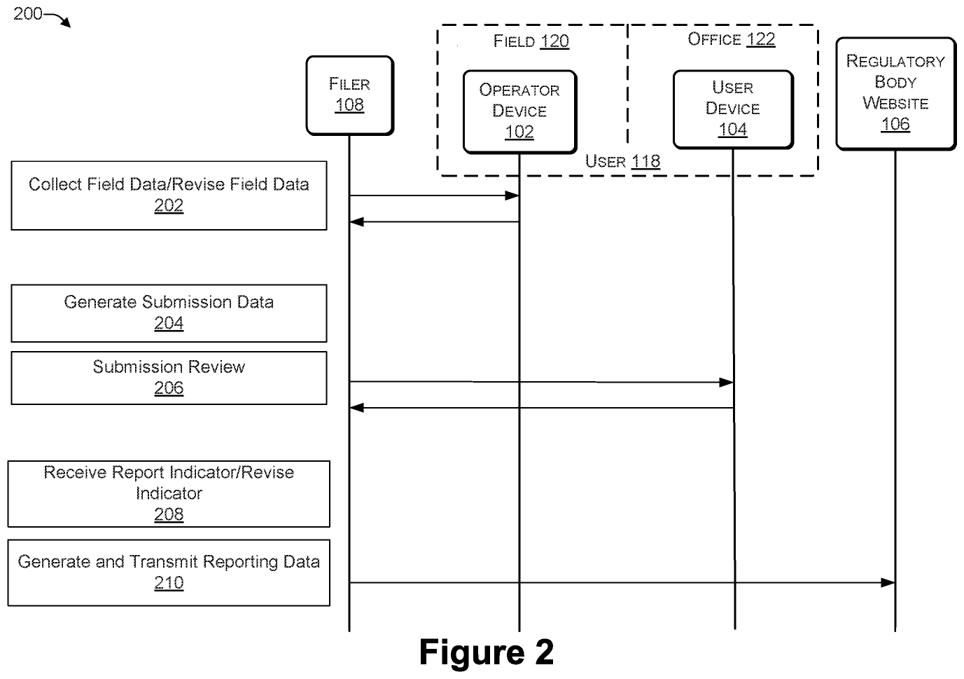

Turning now to FIG. 2, a sequence diagram 200 illustrates a method of using the filer 108, in accordance with some embodiments. In particular, the method illustrates a method of collecting data from a user 118 and transmitting data based on the collected data to the regulatory body website 106. Additional methods and processes may be included within these methods and may be recognized by one of ordinary skill in the art, in light of the description below. Further, in some embodiments, the described methods may be combined, mixed, and matched, as one of ordinary skill would recognize.

In step 202, an operator device 102 logs in to the filer 108 and the filer 108 begins to collect data associated with the operator, job, job location, etc. As described in FIG. 1, the filer 108 collects field data 204. In the event the job is associated with a new well, the filer 108 may receive additional data associated with the new well. The additional data may include: a rig name, a drill floor elevation, a north reference, an elevation, a northing, an easting, a target bearing, a target formation, a latitude, a longitude, a geo system, and a map zone. In the event that the job is associated with an existing well, the filer 108 may access data in the database 110 and transmit the data associated with the existing well to verify the filer 108 has the correct information.

In the event the operator device 102 is responding to a request to revise data associated with a particular job, in step 202, the filer 108 may collect revisions to data previously collected. After a job is marked as complete by the operator device 102, the user device 104 may indicate the data associated with the job needs to be revised. This is one example, in which the filer 108 would collect revised field data from the operator device 102.

After a job is marked complete by the operator device, in step 204, the filer 108 generates submission data (e.g., submission data 116 in FIG. 1). As described herein, generating submission data may include executing various conversions and calculations based on the received field data and formatting the field data and results of the conversions and calculations.

Still referring to FIG. 2, in step 206, the filer 108 submits the submission data for review to the user device 104 (e.g., submission review). In various embodiments, the filer 108 may transmit the submission data to the user device 104. In other embodiments, the user device 104 may log in to the filer 108 and access the submission data. These examples of providing or accessing the submission data are not meant to be limiting and any known methods of providing data to a user device or providing the user device access to the submission data are contemplated within this disclosure.

In step 208, the filer 108 receives a report indicator or a revise indicator. As described in FIG. 1, office personnel may use the user device 104 to review data submitted by a field operator (e.g., submission data). If the office personnel determines the submission data has inaccuracies, the office personnel, through the user device 104, may transmit a revise indicator to the filer 108. In response, the filer 108 may prompt the operator device 102 to revise the previously submitted field data.

If the office personnel determines the submission data is ready for submission, the office personnel, through the user device 104 may transmit a report indicator. The report indicator may have a value of save or submit. That is, the user device 104 specifies to the filer 108 whether to save the data or submit the data using a report indicator.

In step 210, the filer 108 generates and transmits reporting data 210. The filer 108 may format the reporting data according to the formatting rules defined within the filer for submissions to the regulatory body website. For example, the filer 108 may generate filed in a portable document format (pdf) containing the reporting data and a certification statement that confirms the data submitted is accurate and being submitted by the user. Formatting the reporting data is not limited to generating a document having a certain format, formatting also includes providing additional certification statements, and additional forms or data as required by the regulatory body website.

As described in FIG. 2, the filer facilitates data exchange between the user and the regulatory body. The filer introduces efficiencies in data transfers and exchanges that may occur between regulated entities and regulatory body. The filer reduces the time that might be spent by the office personnel to format or generate reporting data, helping to reduce a backlog caused by office bandwidth constraints. Turning now to FIGS. 3-10, various example screens that may be displayed on an operator device 102 or user device 104 are illustrated.

FIGS. 3a-3c show example screens on an operator device, in accordance with some embodiments. FIG. 3a illustrates an example screen 300 of an operator device. The example screen 300 is a log in page that an operator may use to log in and access the filer (e.g., filer 108, FIG. 1). The example log in page includes a box 310 where the operator may input a user name, a box 312 where a user may input a password. The example log in page may also include a submit button 314, that an operator may activate upon entering in a user name and password. The example log in page also includes a register new user button 316 which an operator may active to register a new account. The example log in page also includes a forgot password link 318, that an operator may activate to recover a lost or forgotten password.

FIG. 3b illustrates an example screen 320 of an operator device following a log in screen. After an operator logs in, the operator may be prompted as to whether he is working on a new well or an existing well. Upon indicating that the work is being performed on an existing well, the example screen 320 is presented in which the operator is prompted to enter information about the existing well. The information that an operator is prompted to enter may include: a state where the well is located, a county where the well is located, a well number of the existing well, a well body, and an API number. The operator may activate the submit button 322 to transmit the information to the filer (e.g., filer 108, FIG. 1). In response to receiving the information from the operator device, the filer may query the database coupled to the filer (e.g., database 110) for additional data associated with the existing well. The information in the database (e.g., database 110) in turn reflects information stored by the regulatory body.

In the event the data submitted by the operator is not recognized by the filer, the filer may prompt the operator to input subsequent data themselves. For example, if the filer does not recognize an API #, instead of displaying additional data (e.g., FIG. 3c), the filer prompts the operator to submit subsequent data including but not limited to: an API number, a district, a lease party, a well number, a permitted operator, a state, a county, a wellbore profile, a total depth, a latitude, and a longitude. That is, the filer may collect data about a well from the user 118 in conjunction with the regulatory body.

FIG. 3c illustrates an example screen 340 of an operator device in which the filer displays the additional data. For example, the filer may retrieve additional information such as the district the existing well is located in, information on the lease, a permitted operator, a wellbore profile of the existing well, a total depth, latitude, and longitude and prompt the operator device to confirm the displays information is correct. The operator may confirm an accuracy of the additional information by activating either a yes button 342 or a no button 344 at the bottom of the display.

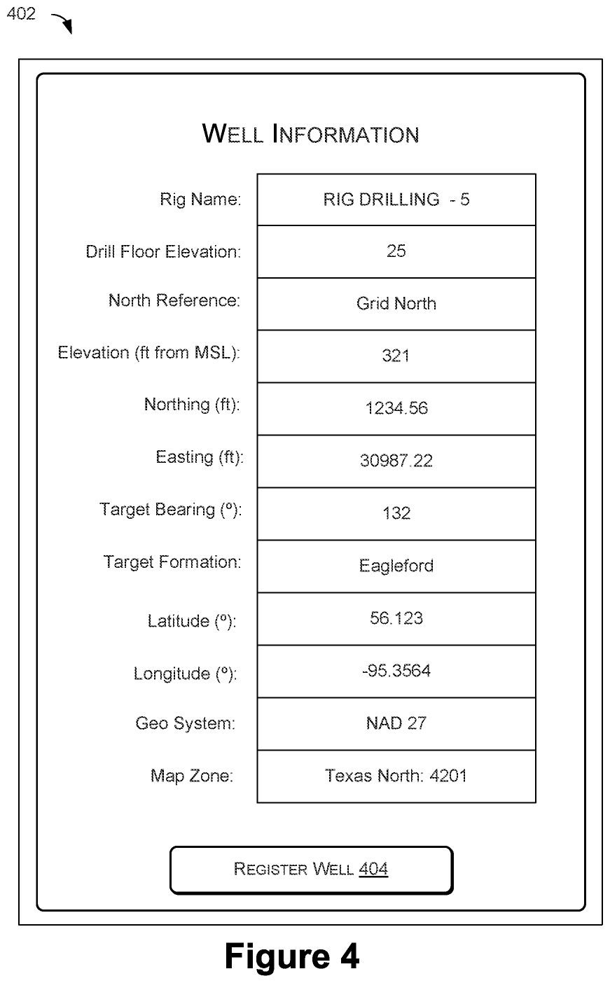

FIG. 4 shows an example screen on an operator device, in accordance with some embodiments. FIG. 4 illustrates an example screen 402 of an operator device following a log in screen. After an operator logs in, the operator may be prompted to indicate whether he is working on a new well or an existing well. Upon indicating that the work is being performed on a new well, the example screen 402 is presented in which the operator is prompter to enter information about the new well. The information that an operator is prompted to enter may include: a rig name, a drill floor elevation, a north reference, an elevation, a northing, an easting, a target bearing, a target formation, a latitude, a longitude, a geo system, and a map zone. The operator may activate the register well button 404 to transmit the information to the filer (e.g., filer 108, FIG. 1).

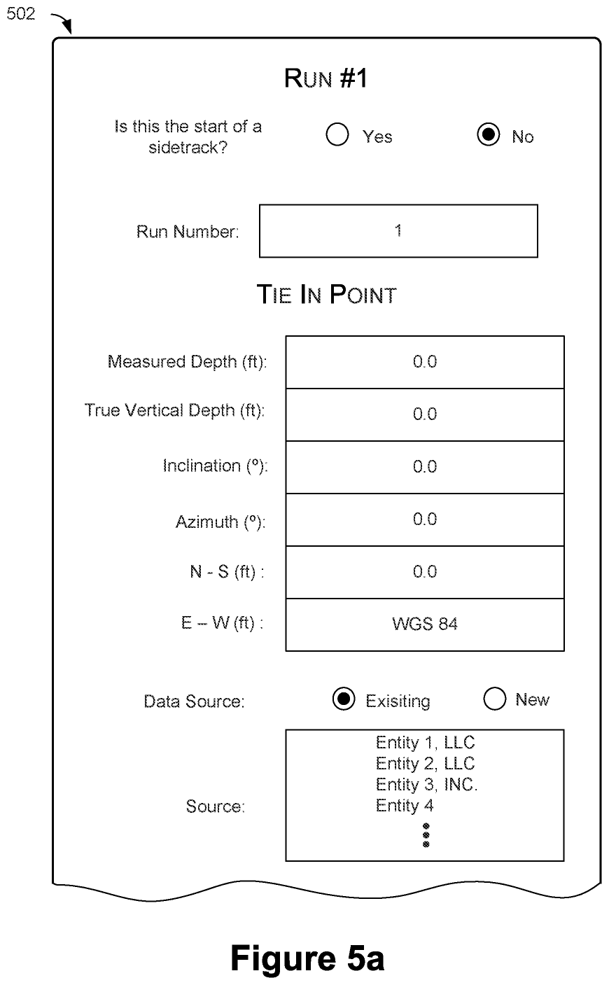

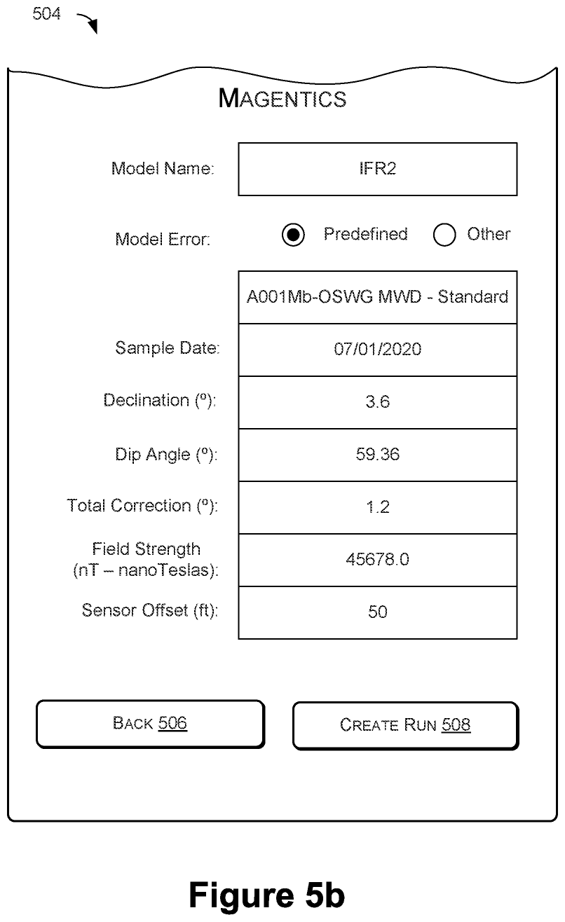

FIGS. 5a-5b illustrate examples screens of an operator device, in accordance with some embodiments. Specifically, FIGS. 5a and 5b illustrate an example screen (run information screen) presented to an operator regarding a respective run. After entering new or existing well information, the filer (e.g., filer 108, FIG. 1) begins collecting field data.

In the example screen 502, an operator may be prompted to indicate whether the run is part of a sidetrack, indicate a run number, and provide information related to the tie-in point. For example, information related to the tie-in point may include a measured depth, true vertical depth, inclination, azimuth, N-S (ft), E-W (ft), and a data source.

FIG. 5b illustrates additional portions of the run information screen. In the example screen 504, an operator may put in information related to magnetics. For example, an operator may specify a magnetics model being used, whether the model error is predefined or other, a sample date, a declination, a dip angle, a total correction, a field strength and a sensor offset. The operator may return back to a previous screen by activating the back button 506, or create a run by activating the create run button 508.

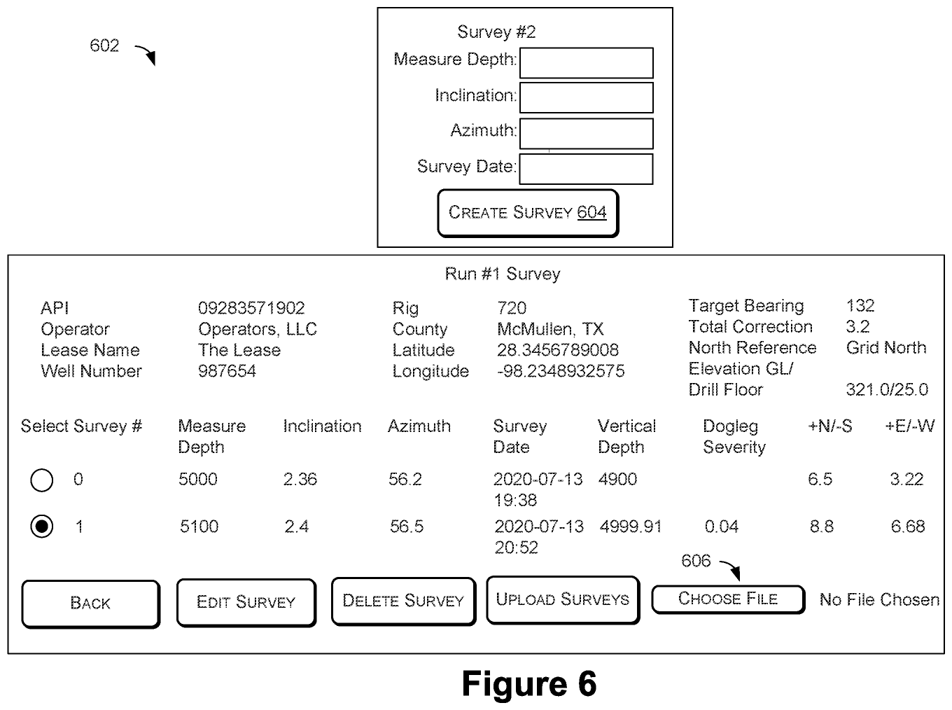

FIG. 6 illustrates an example screen on an operator device, in accordance with some embodiments. In the example screen 602, the operator may have an option to create survey (e.g., create survey 604), or alternatively, view information associated with various surveys. Furthermore, an operator may submit data associated with a well by uploading data captured in a file (e.g., choose file 606). For example, various tools may capture data associated with a run and store the data in an electronic format (e.g., EXCEL, WORD, PDF, etc.). An operator may choose a file storing data to upload information associated with a particular survey.

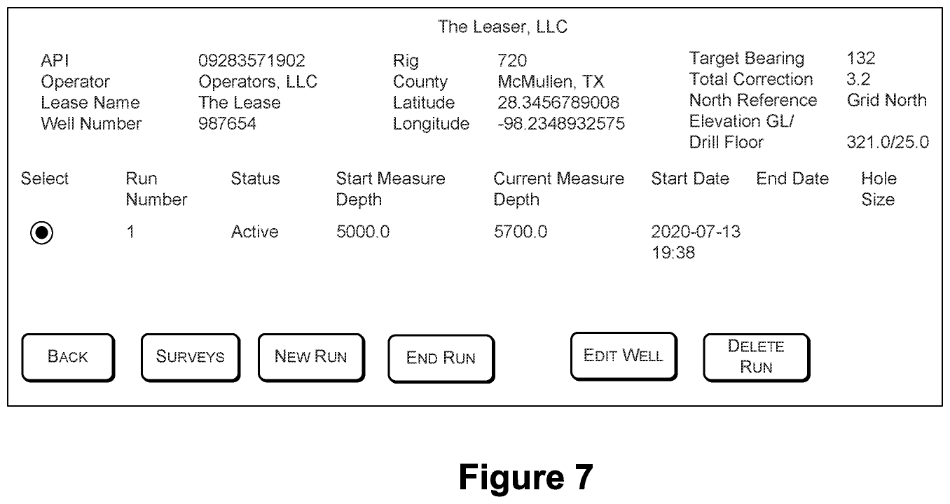

FIG. 7 illustrates an example screen on an operator device, in accordance with some embodiments. In the example screen 702, the operator may view information related to a particular run, may access surveys associated with the drilling, create a new run, end a run, edit a well information, and delete a run.

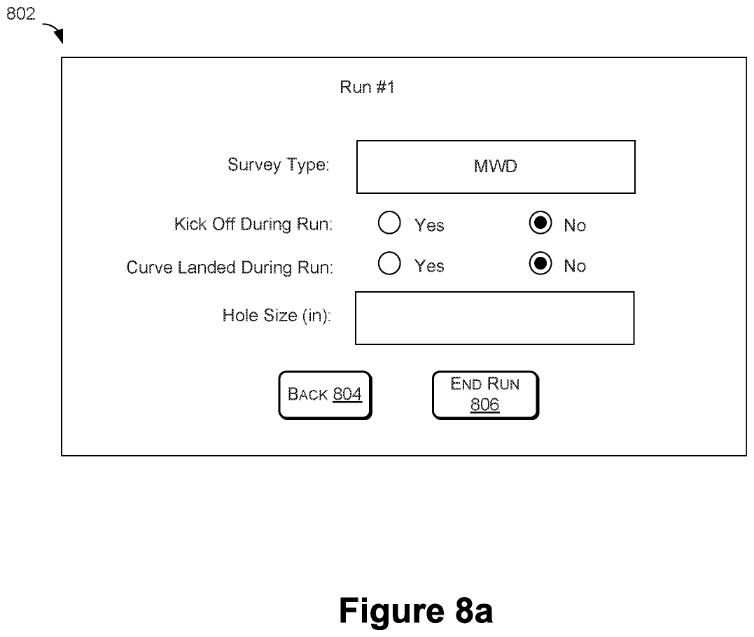

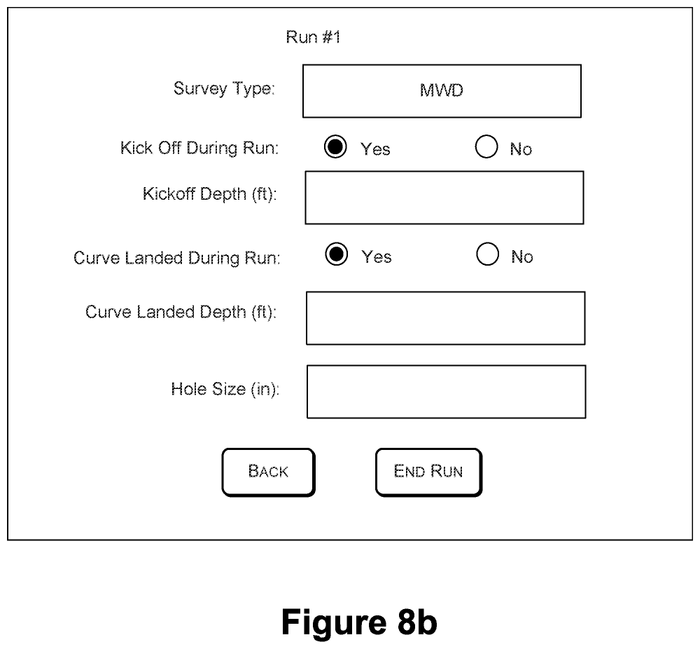

FIGS. 8a-8b illustrate example screens on an operator device, in accordance with some embodiments. In the example screen 802, an operator chooses to edit a run, and is presented with the screen 802. The operator may input data including: survey type, whether there was a kick off during run, a curve landed during run, and a hole size. In the example screen 802, there was not a kick off and no curve landed during the run. The operator may choose to go to a previous screen by activating the back button 804 or end the run by activating the end run button 806.

FIG. 8b illustrates the screen in FIG. 8a, however, in this example, the operator indicates there is kick off during the run and curve landed during the run. In response, additional fields are displayed in which the operator can input a kickoff depth and a curve landed depth.

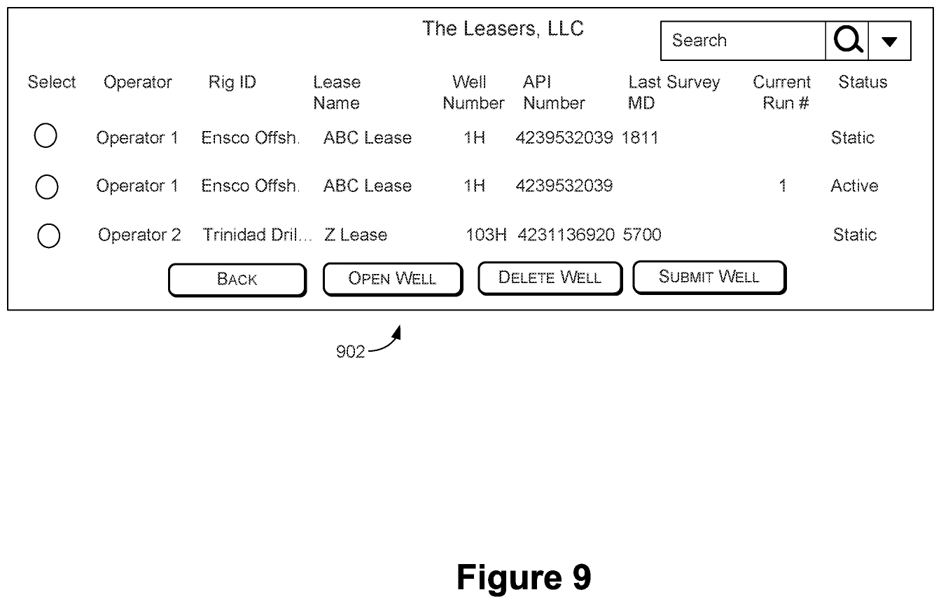

FIG. 9 illustrates a screen on an operator device, in accordance with some embodiments. In the example screen 902, the filer displays various surveys associated with a respective leaser or regulated entity. The operator may select a particular job and open a well, delete the well, or submit the well. Upon submitting the well, the filer generates submission data and presents the submission data to office personnel. Accordingly FIGS. 3-9 illustrate respective screens on an operator device that may be displayed when a field operator logs in to the filer.

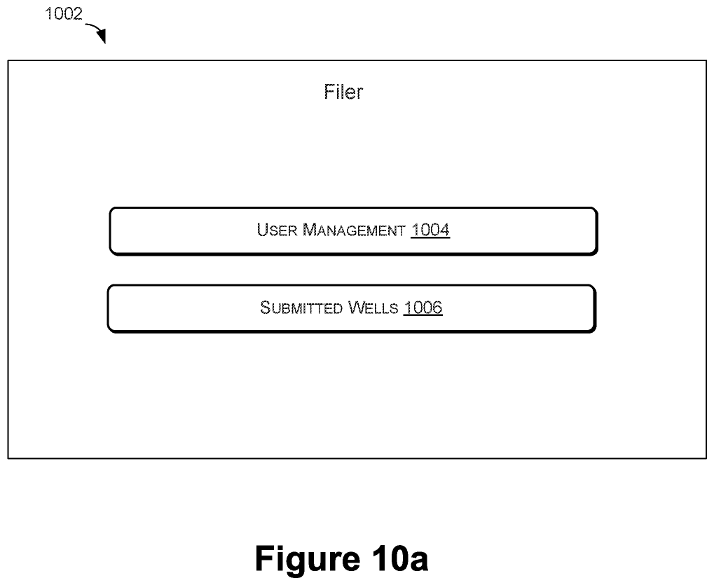

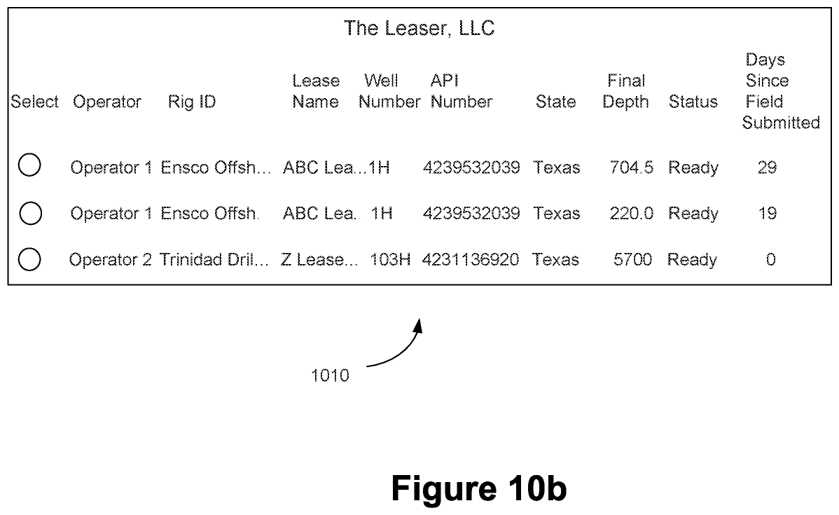

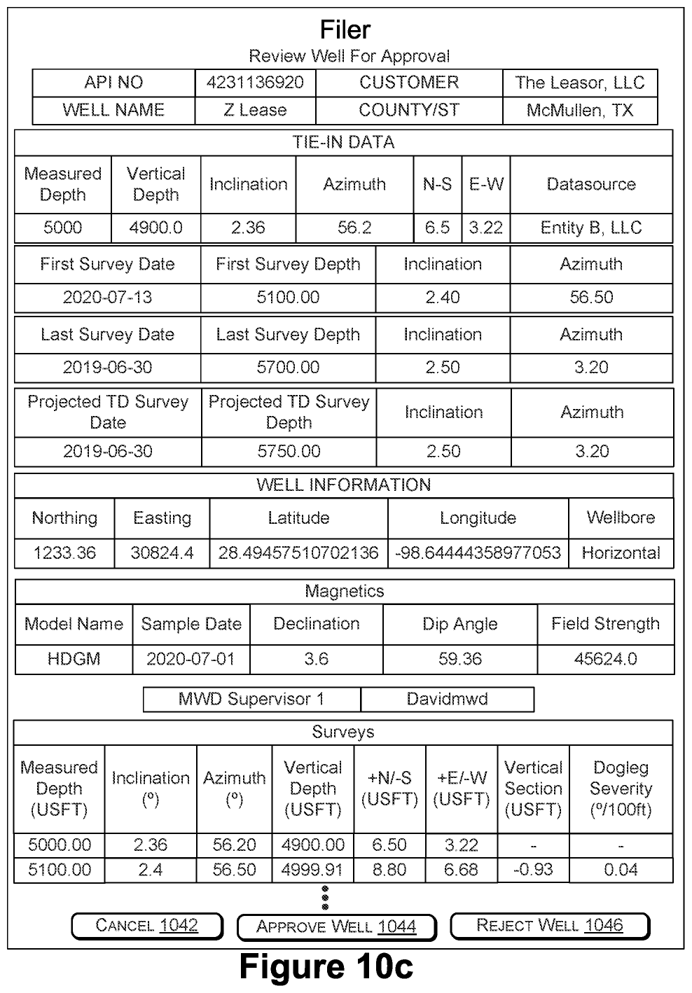

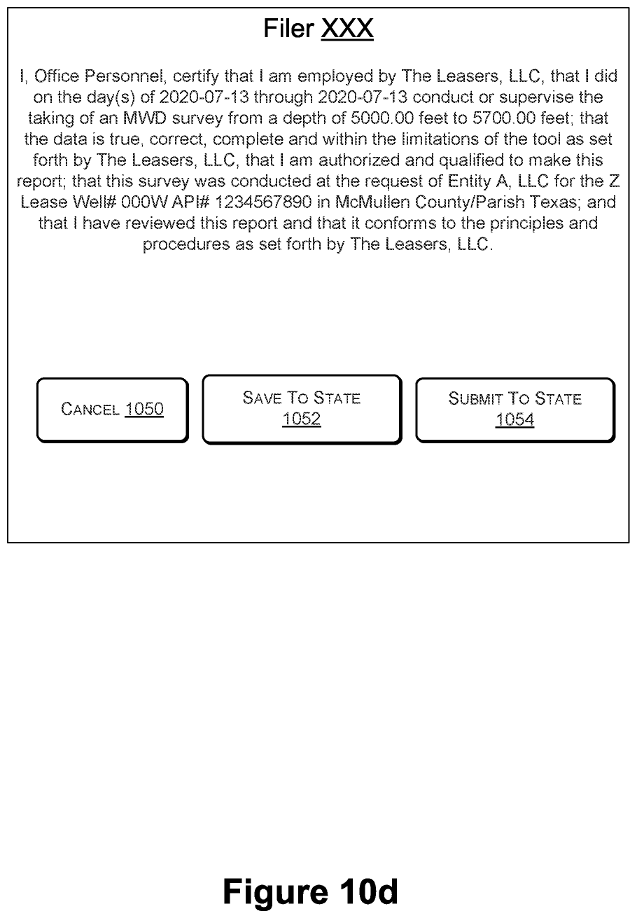

FIGS. 10a-10d illustrate example screens of a user device (e.g., user device. FIG. 10a illustrates an example screen 1002 where office personnel using a user device may login in to the filer. The office personnel may choose to manage an account (e.g., user management button 1004), or review submitted wells (submitted wells button 1006)

FIG. 10b illustrates an example screen 1010 after a user has activated the submitted wells button 1006. In the example screen 1010, the user may select wells that have been submitted through an operator device. After selecting a particular well, the user may view submission data.

FIG. 10c illustrates an example screen in which the user views submission data. The example submission data illustrates information related to a well including: API number, well name, customer, county, state, tie-in data, well information, magnetics, and survey data. The tie-in data may include information such as: measured depth, vertical depth, inclination, azimuth, N-S, E-W, and a data source. The submission data also includes data associated with surveys and respective dates of the surveys. Well information may include a northing, easting, latitude, longitude, and wellbore information. The magnetics may include a magnetics model name, a sample date, a declination, a dip angle, and a field strength. The example submission data also shows data associated with respective surveys including: measured depth, inclination, azimuth, vertical depth, +N/−S, +E/−W, vertical section, and dogleg severity.

Office personnel may cancel the review process by activating the cancel button 1042. Office personnel may also approve the well by activating the approve well button 1044, where the user device may transmit a report indicator. In the office personnel finds inaccuracies in the submission data, the office personnel may reject the well by activating the reject well button 1046, where the user device transmits a revise indicator.

FIG. 10d illustrates an example certification statement generated by the filer as part of the process of generating submission data. In FIG. 10d, the example certification statement states: “I, Office Personnel, certify that I am employed by The Leasers, LLC, that I did on the day(s) of 2020-07-13 through 2020-07-13 conduct or supervise the taking of an MWD survey from a depth of 5000.00 feet to 5700.00 feet; that the data is true, correct, complete and within the limitations of the tool as set forth by The Leasers, LLC, that I am authorized and qualified to make this report; that this survey was conducted at the request of Entity A, LLC for the Z Lease Well #000W API #1234567890 in McMullen County/Parish Tex.; and that I have reviewed this report and that it conforms to the principles and procedures as set forth by The Leasers, LLC.” The user of the user device may choose to cancel the process by activating the cancel button 1050. Additionally, the user of the user device may choose to save the submission data to the regulatory body website without submitting the submission data by activating the save to state button 1052. The user of the user device may choose to submit the submission data to the regulatory body website by activating the submit to state 1054. Accordingly, FIGS. 10a-10d illustrate respective screens on a user device that may be displayed when office personnel log in to the filer.

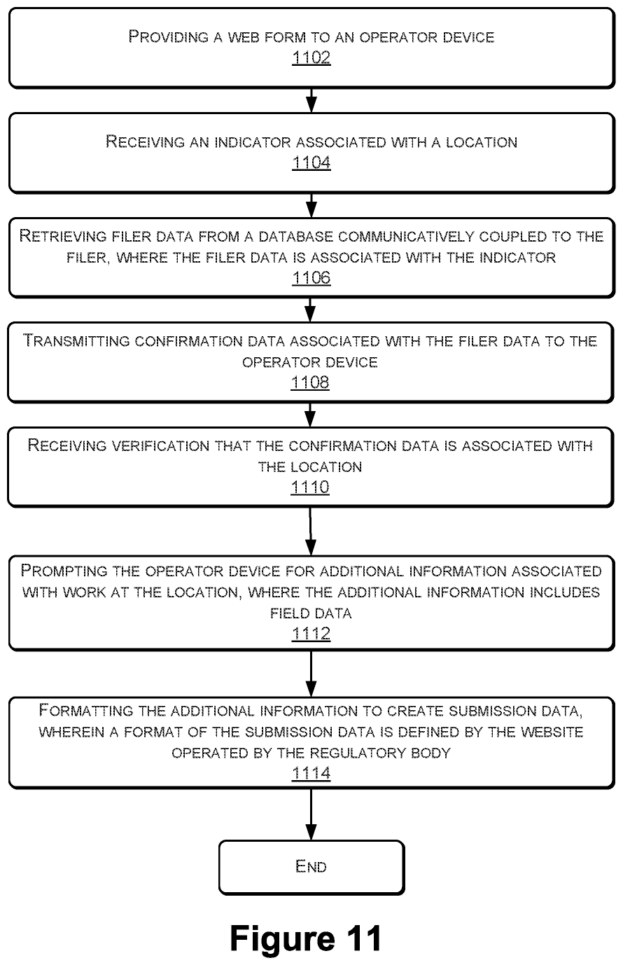

FIG. 11 illustrates a method that may be performed by a filer communicatively coupled to an operator device as described herein. In various embodiments, some of the blocks shown in FIG. 11 may be performed concurrently, in a different order than shown, or omitted. Additional method elements may also be performed as desired. The method begins at block 1102 where a filer provides a web form to an operator device. At block 1104, the operator receives an indicator associated with a location. The indicator associated with the location includes at least one selected from the group consisting of: a well number, a well bore identifier, and an API number.

At block 1106, the filer retrieves filer data from a database communicatively coupled to the filer, where the filer data is associated with the indicator. At block 1108, the filer transmits confirmation data associated with the filer data to the operator device. In some examples, the confirmation data is described and illustrated in FIG. 3c.

At block 1110, the filer receives verification that the confirmation data is associated with the location. For example, upon being asked whether the displayed information is correct, the user device responds with yes. At block 1112, the filer prompts the operator device for additional information associated with work at the location, where the additional information includes field data.

At block 1114, the filer formats the additional information to create submission data, where a format of the submission data is defined by the website operated by the regulatory body. Creating or generating submission data may include using the field data and calculating additional data. Creating or generating submission data may also include retrieving plat information associated with a particular well. In one example, the plat information is retrieved from the database coupled to the filer. Creating or generating submission data may also include creating a certification statement (e.g., FIG. 10d). Thereafter the method ends.

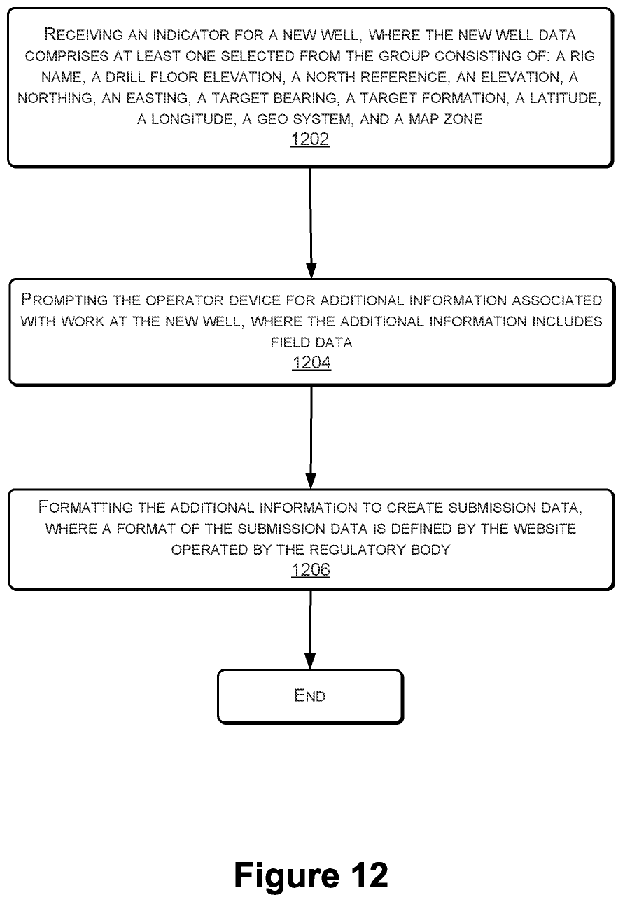

FIG. 12 illustrates a method that may be performed by a filer communicatively coupled to an operator device as described herein. In various embodiments, some of the blocks shown in FIG. 12 may be performed concurrently, in a different order than shown, or omitted. Additional method elements may also be performed as desired. The method begins at block 1202 where a filer receives an indicator for a new well, where the new well data includes at least one selected from the group including: a rig name, a drill floor elevation, a north reference, an elevation, a northing, an easting, a target bearing, a target formation, a latitude, a longitude, a geo system, and a map zone.

At block 1204, the filer prompts the operator device for additional information associated with work at the new well, where the additional information includes field data. At block 1206, the filer formats the additional information to create submission data, where a format of the submission data is defined by the website operated by the regulatory body. Thereafter the method ends.

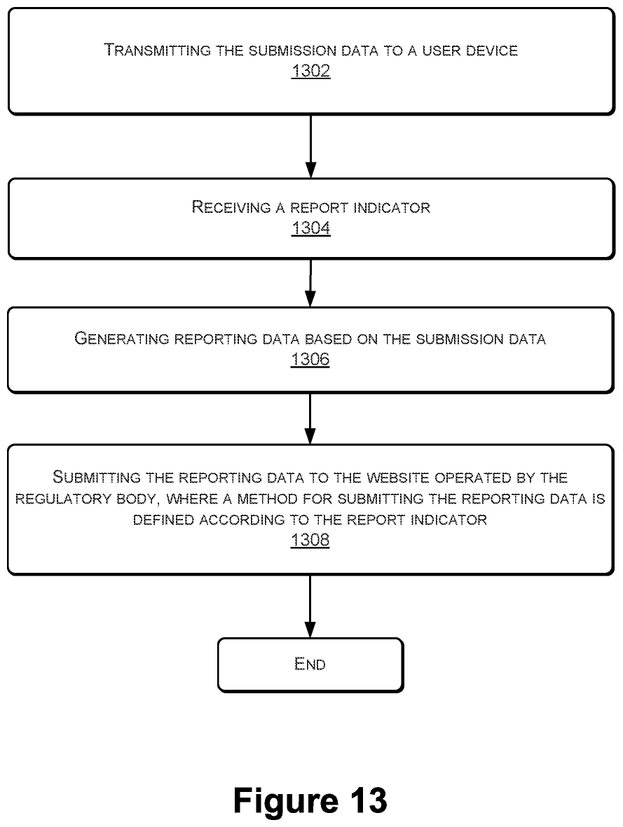

FIG. 13 illustrates a method that may be performed by a filer communicatively coupled to a user device as described herein. In various embodiments, some of the block shown in FIG. 13 may be performed concurrently, in a different order than shown, or omitted. Additional method elements may also be performed as desired. The method begins at block 1302, where the filer transmits submission data to a user device. At block 1304, the filer receives a report indicator. The report indicator may have one of two values: submit value or a save value.

At block 1306, the filer generator reporting data based on the submission data. At block 1308 the filer submits the reporting data to the website operated by the regulatory body, where method for submitting the reporting data is defined according to the report indicator. For example, if the report indicator has a save value, the filer causes the reporting data to be saved under an associated user account with the website of the regulatory body. If the report indicator has a submit value, the filer causes the reporting data to be submitted at the website of the regulatory body.

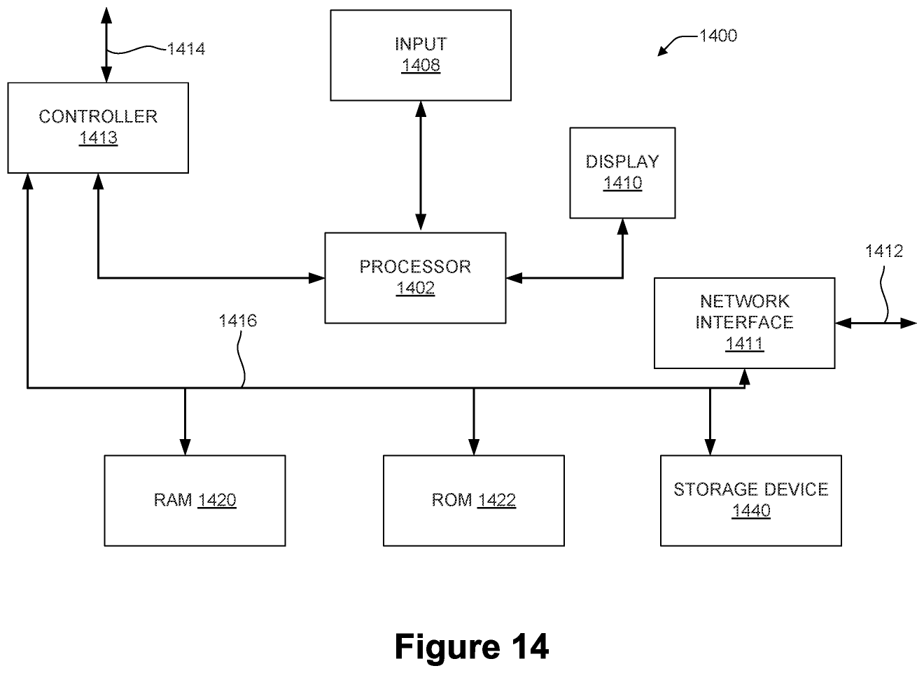

FIG. 14 illustrates a detailed view of a computing device 1400 that can represent the computing devices described herein used to implement the various techniques described herein. For example, the detailed view illustrates various components that can be included in the operator device 102, the user device 104, a computing device executing the filer 108, a computing device implementing the database 110, or a computing device implementing the regulatory body website.

As shown in FIG. 14, the computing device 1400 can include a processor 1402 that represents a microprocessor or controller for controlling the overall operation of the computing device 1400. The computing device 1400 can also include a user input device 1408 that allows a user of the computing device 1400 to interact with the computing device 1400. For example, the user input device 1408 can take a variety of forms, such as a button, keypad, dial, touch screen, audio input interface, visual/image capture input interface, input in the form of sensor data, and so on. Still further, the computing device 1400 can include a display 1410, controlled by the processor 1402 (e.g., via a graphics component) to display information to the user. A data bus 1416 can facilitate data transfer between at least a storage device 1440, the processor 1402, and a controller 1413. The controller 1413 can be used to interface with and control different equipment through an equipment control bus 1414. The computer device 1400 can also include a network/bus interface 1411 that couples to a data link 1412. In the case or a wireless connection, the network/bus interface 1411 can include a wireless transceiver.

As noted above, the computing device 1400 also includes the storage device 1440, which can comprise a single disk or a collection of disks (e.g., hard drives). In some embodiments, storage device 1440 can include flash memory, semiconductor (solid state) memory or the like. The computing device 1400 can also include a Random Access Memory (RAM) 1420 and a Read-Only Memory (ROM) 1422. The ROM 1422 can store programs, utilities, or processes to be executed in a non-volatile manner. The RAM 1420 can provide volatile data storage, and stores instructions related to the operation of applications executing on the computing device 1400.

Consistent with the above disclosure, the examples enumerated in the following clauses are specifically contemplated and are intended as a non-limiting set of examples.

Clause 1. A method of implementing a filer configured to interface between an operator device and a website operated by a regulatory body, the method comprising the filer:
providing a web form to the operator device;
receiving an indicator associated with a location;
retrieving filer data from a database communicatively coupled to the filer, wherein the filer data is associated with the indicator;
transmitting confirmation data associated with the filer data to the operator device;
receiving verification that the confirmation data is associated with the location;
prompting the operator device for additional information associated with work at the location, wherein the additional information includes field data; and
formatting the additional information to create submission data, wherein a format of the submission data is defined by the website operated by the regulatory body.

Clause 2. The method of claim 1, wherein formatting the additional information to create submission data further comprises: calculating a dogleg severity or a vertical section.

Clause 3. The method of any preceding clause, wherein the indicator associated with the location comprises at least one selected from the group consisting of: a well number, a well bore identifier, and an API number.

Clause 4. The method of any preceding clause, wherein the information associated with the indicator further comprises at least one selected from the group consisting of: a district number, a lease name, a permitted operator name, a state, a county, a wellbore profile, a total depth, a latitude, and a longitude.

Clause 5. The method of any preceding clause, further comprising: receiving an additional indicator for a new well; and
receiving new well information associated with the new well, wherein the new well information comprises at least one selected from the group consisting of: a rig name, a drill floor elevation, a north reference, an elevation, a northing, an easting, a target bearing, a target formation, a latitude, a longitude, a geo system, and a map zone.

Clause 6. The method of any preceding clause, wherein the additional information further comprises information associated with a run operation that comprises at least one selected from the group consisting of: a run number, a measure depth, a vertical depth, an inclination, an azimuth, a north to south distance, an east to west distance, a data source identifier, a model name, a sample date, a declination, a dip angle, a total correction, a field strength, and a sensor offset.

Clause 7. The method of any preceding clause, further comprising:
transmitting the submission data, by the filer, to an office device, different from the operator device;
receiving a report indicator;
generating reporting data based on the submission data; and
submitting the reporting data to the website operated by the regulatory body, wherein a method for submitting the reporting data is defined according to the report indicator.

Clause 8. The method according to clause 7, wherein the report indicator comprises a value of submit, and the method further comprises:
based on the report indicator, submitting the reporting data further comprises submitting the reporting data to the website operated by the regulatory body, wherein the filer comprises.

Clause 9. The method according to claim 7, wherein the report indicator comprises a value of save, and the method further comprises:
based on the report indicator, saving the submission data to the website operated by the regulatory body, without submitting the submission data.

Clause 10. The method of any preceding clause, further comprising:
querying, by the filer, the website operated by the regulatory body, for database information associated with one or more locations, wherein the database information is stored in a storage associated with the website operated by the regulatory body;
receiving the database information; and
storing the database information as filer data in the database communicatively coupled to the filer.

Clause 11. One or more non-transitory computer-readable storage media storing instructions that when executed by one or more processors of a computing system, cause the computing system to perform operations comprising:
provide, by a filer, a web form to an operator device, wherein the filer is configured to interface between the operator device and a website operated by a regulatory body;
receive, by the filer, an indicator associated with a location;
retrieve, by the filer, filer data from a database communicatively coupled to the filer, wherein the filer data is associated with the indicator;
transmit, by the filer, confirmation data to the operator device, wherein the confirmation data is associated with the filer data;
receive, by the filer, verification that the confirmation data is associated with the location;
prompt, by the filer, the operator device for additional information associated with work at the location, wherein the additional information includes field data; and
format, by the filer, the additional information to create submission data, wherein a format of the submission data is defined by the website operated by the regulatory body.

Clause 12. The one or more non-transitory computer-readable storage media of any preceding clause, wherein the instructions further cause the computing system to perform operations comprising:
transmit the submission data, by the filer, to an office device different from the operator device;
receive, by the filer, a report indicator;
generate, by the filer, reporting data based on the submission data; and
submit, by the filer, the reporting data to the website operated by the regulatory body, wherein a method for submitting the reporting data is defined according to the report indicator.

Clause 13. The one or more non-transitory computer-readable storage media according to clause 12, wherein:
the report indicator comprises at least one selected from the group consisting of: a submit value, and a save value.

Clause 14. The one or more non-transitory computer-readable storage media of any preceding clause, wherein the indicator associated with the location comprises at least one selected from the group consisting of: a well number, a well-bore identifier, and an API number.

Clause 15. The one or more non-transitory computer-readable storage media of any preceding clause, wherein the instructions further cause the computing system to perform operations comprising:
receive an additional indicator for a new well; and
receive new well information associated with the new well, wherein the new well information comprises at least one selected from the group consisting of: a rig name, a drill floor elevation, a north reference, an elevation, a northing, an easting, a target bearing, a target formation, a latitude, a longitude, a geo system, and a map zone.

Clause 16. A system configured to implement a filer that interfaces between an operator device and a website operated by a regulatory body, comprising:
a processor;
a memory coupled to the processor;
the memory storing a program that, when executed by the processor, causes the system to:
   provide a web form to the operator device;
   receive an indicator for a new well from the operator device;
   receive new well data associated with the new well, wherein the new well data comprises at least one selected from the group consisting of: a rig name, a drill floor elevation, a north reference, an elevation, a northing, an easting, a target bearing, a target formation, a latitude, a longitude, a geo system, and a map zone;
   prompt the operator device for additional information associated with work at the new well, wherein the additional information includes field data;
   and format the additional information to create submission data, wherein a format of the submission data is defined by the website operated by the regulatory body.

Clause 17. The system of any preceding clause, wherein the program further causes the system to:
receive an indicator associated with a location;
retrieve filer data from a database communicatively coupled to the filer, wherein the filer data is associated with the indicator;
transmit confirmation data associated with the filer data to the operator device;
receive verification that the confirmation data is associated with the location; in response to receiving the verification;
prompt the operator device for additional information associated with work at the location, wherein the additional information includes field data; and
format the additional information to create second submission data, wherein a format of the second submission data is defined by the website operated by the regulatory body.

Clause 18. The system according to clause 17, wherein the indicator associated with the location comprises at least one selected from the group consisting of: a well number, a well bore identifier, and an API number.

Clause 19. The system according to clause 17, wherein the program further causes the system to:
query the website operated by the regulatory body for database information associated with one or more locations, wherein the database information is stored in a storage associated with the website operated by the regulatory body;
receive the database information; and
store the database information.

Clause 20. The system of any preceding clause, wherein the program further causes the system to:
transmit the submission data to an office device;
receive a report indicator;
generate reporting data based on the submission data; and
submit the reporting data to the website operated by the regulatory body, wherein a method for submitting the reporting data is defined according to the report indicator.

References to “one embodiment”, “an embodiment”, “some embodiments”, “various embodiments”, or the like indicate that a particular element or characteristic is included in at least one embodiment of the invention. Although the phrases may appear in various places, the phrases do not necessarily refer to the same embodiment or example.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A method of implementing a filer configured to interface between an operator device and a website operated by a regulatory body, the method comprising the filer:
providing a web form to the operator device;
receiving an indicator associated with a location;
retrieving filer data from a database communicatively coupled to the filer, wherein the filer data is associated with the indicator;
transmitting confirmation data associated with the filer data to the operator device;
receiving verification that the confirmation data is associated with the location;
prompting the operator device for additional information associated with work at the location, wherein the additional information includes field data; and
formatting the additional information to create submission data, wherein a format of the submission data is defined by the website operated by the regulatory body.

2. The method of claim 1, wherein formatting the additional information to create submission data further comprises: calculating a dogleg severity or a vertical section.

3. The method of claim 1, wherein the indicator associated with the location comprises at least one selected from the group consisting of: a well number, a well bore identifier, and an API number.

4. The method of claim 1, wherein the information associated with the indicator further comprises at least one selected from the group consisting of: a district number, a lease name, a permitted operator name, a state, a county, a wellbore profile, a total depth, a latitude, and a longitude.

5. The method of claim 1, further comprising:
receiving an additional indicator for a new well; and
receiving new well information associated with the new well, wherein the new well information comprises at least one selected from the group consisting of: a rig name, a drill floor elevation, a north reference, an elevation, a northing, an easting, a target bearing, a target formation, a latitude, a longitude, a geo system, and a map zone.

6. The method of claim 1, wherein the additional information further comprises information associated with a run operation that comprises at least one selected from the group consisting of: a run number, a measure depth, a vertical depth, an inclination, an azimuth, a north to south distance, an east to west distance, a data source identifier, a model name, a sample date, a declination, a dip angle, a total correction, a field strength, and a sensor offset.

7. The method of claim 1, further comprising:
transmitting the submission data, by the filer, to an office device, different from the operator device;
receiving a report indicator;
generating reporting data based on the submission data; and
submitting the reporting data to the website operated by the regulatory body, wherein a method for submitting the reporting data is defined according to the report indicator.

8. The method of claim 7, wherein the report indicator comprises a value of submit, and the method further comprises:
based on the report indicator, submitting the reporting data further comprises submitting the reporting data to the website operated by the regulatory body, wherein the filer comprises.

9. The method of claim 7, wherein the report indicator comprises a value of save, and the method further comprises:
based on the report indicator, saving the submission data to the website operated by the regulatory body, without submitting the submission data.

10. The method of claim 1, further comprising:
querying, by the filer, the website operated by the regulatory body, for database information associated with one or more locations, wherein the database information is stored in a storage associated with the website operated by the regulatory body;
receiving the database information; and
storing the database information as filer data in the database communicatively coupled to the filer.

11. One or more non-transitory computer-readable storage media storing instructions that when executed by one or more processors of a computing system, cause the computing system to perform operations comprising:
provide, by a filer, a web form to an operator device, wherein the filer is configured to interface between the operator device and a website operated by a regulatory body;
receive, by the filer, an indicator associated with a location;
retrieve, by the filer, filer data from a database communicatively coupled to the filer, wherein the filer data is associated with the indicator;
transmit, by the filer, confirmation data to the operator device, wherein the confirmation data is associated with the filer data;
receive, by the filer, verification that the confirmation data is associated with the location;
prompt, by the filer, the operator device for additional information associated with work at the location, wherein the additional information includes field data; and
format, by the filer, the additional information to create submission data, wherein a format of the submission data is defined by the website operated by the regulatory body.

12. The one or more non-transitory computer-readable storage media of claim 11, wherein the instructions further cause the computing system to perform operations comprising:
transmit the submission data, by the filer, to an office device different from the operator device;
receive, by the filer, a report indicator;
generate, by the filer, reporting data based on the submission data; and
submit, by the filer, the reporting data to the website operated by the regulatory body, wherein a method for submitting the reporting data is defined according to the report indicator.

13. The one or more non-transitory computer-readable storage media of claim 12, wherein:
the report indicator comprises at least one selected from the group consisting of: a submit value, and a save value.

14. The one or more non-transitory computer-readable storage media of claim 11, wherein the indicator associated with the location comprises at least one selected from the group consisting of: a well number, a well-bore identifier, and an API number.

15. The one or more non-transitory computer-readable storage media of claim 11, wherein the instructions further cause the computing system to perform operations comprising:
receive an additional indicator for a new well; and
receive new well information associated with the new well, wherein the new well information comprises at least one selected from the group consisting of: a rig name, a drill floor elevation, a north reference, an elevation, a northing, an easting, a target bearing, a target formation, a latitude, a longitude, a geo system, and a map zone.

16. A system configured to implement a filer that interfaces between an operator device and a website operated by a regulatory body, comprising:
a processor;
a memory coupled to the processor;
the memory storing a program that, when executed by the processor, causes the system to:
provide a web form to the operator device;
receive an indicator for a new well from the operator device;
receive new well data associated with the new well, wherein the new well data comprises at least one selected from the group consisting of: a rig name, a drill floor elevation, a north reference, an elevation, a northing, an easting, a target bearing, a target formation, a latitude, a longitude, a geo system, and a map zone;
prompt the operator device for additional information associated with work at the new well, wherein the additional information includes field data; and
format the additional information to create submission data, wherein a format of the submission data is defined by the website operated by the regulatory body.

17. The system of claim 16, wherein the program further causes the system to:
receive an indicator associated with a location;
retrieve filer data from a database communicatively coupled to the filer, wherein the filer data is associated with the indicator;
transmit confirmation data associated with the filer data to the operator device;
receive verification that the confirmation data is associated with the location; in response to receiving the verification;
prompt the operator device for additional information associated with work at the location, wherein the additional information includes field data; and
format the additional information to create second submission data, wherein a format of the second submission data is defined by the website operated by the regulatory body.

18. The system of claim 17, wherein the indicator associated with the location comprises at least one selected from the group consisting of: a well number, a well bore identifier, and an API number.

19. The system of claim 17, wherein the program further causes the system to:
query the website operated by the regulatory body for database information associated with one or more locations, wherein the database information is stored in a storage associated with the website operated by the regulatory body;
receive the database information; and
store the database information.

20. The system of claim 16, wherein the program further causes the system to:
transmit the submission data to an office device;
receive a report indicator;
generate reporting data based on the submission data; and
submit the reporting data to the website operated by the regulatory body, wherein a method for submitting the reporting data is defined according to the report indicator.
